(19) United States
(12) Patent Application Publication
(10) Pub. No.: US 2014/0278404 A1
(43) Pub. Date: Sep. 18, 2014

(54) AUDIO MERGE TAGS

(71) Applicant: PARLANT TECHNOLOGY, INC., Provo, UT (US)

(72) Inventors: Tyson Holmes, American Fork, UT (US); Daniel Stovall, Provo, UT (US)

(73) Assignee: Parlant Technology, Inc., Provo, UT (US)

(21) Appl. No.: 13/838,246

(22) Filed: Mar. 15, 2013

(51) Int. Cl. G10L 13/04; G10L 15/26

(52) U.S. Cl. CPC G10L 13/043; G10L 15/265
USPC 704/235

(57) ABSTRACT

A method of creating a message. The method includes recording a message. The method also includes identifying an audio merge tag in the message. The method further includes replacing the audio merge tag with alternative audio.

### CROSS-REFERENCE TO RELATED APPLICATIONS

Not applicable.

### BACKGROUND OF THE INVENTION

Merge codes are used for mass mailings to personalize a message to the recipient. In text, they are widespread in applications from mass marketing to wedding announcements. Merge codes, however, have not received widespread use in audio messages. When used, it is often with an entirely synthesized voice such as Apple Inc.'s Siri personal assistant application, or in restricted natural voice settings where separate audio files are used together.

More natural, but still flexible, mass audio messages can be created with various audio files, such as files of a user saying words, to create a message. This is inferior in conveying information because separately recorded sound segments create a “staccato” (choppy) effect due to subtle tone variations by the speaker. When people record a more homogeneous message they tend to speak in a more flowing, natural manner.

However, recipients tend to dismiss such messages easily. In particular, recipients hear the “machine” voice or staccato effect and assume that the message is “spam” or mass messaging. However, this assumption is not always correct. I.e., the message may be personalized and contain information that is important to the recipient. Therefore, the recipient may miss important information.

Nevertheless, the mass creation of messages may be necessary in order to convey information. For example, producing individualized messages without human intervention can ensure that the message does not “fall through the cracks.” I.e., automatic creation of the message can ensure that the message is created and delivered. Further, the number of messages may be too great to create them individually or may fluctuate based on specific events, making the creation of individual messages difficult. For example, many teachers have many responsibilities and find it difficult to call the parents of each student on a regular basis.

Accordingly, there is a need in the art for a system which can automatically create desired audio messages. Further, there is a need in the art for the system to produce a natural sounding message.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of creating a message. The method includes recording a message. The method also includes identifying an audio merge tag in the message. The method further includes replacing the audio merge tag with alternative audio.

Another example embodiment includes a non-transitory computer-readable storage medium in a computing system including instructions that, when executed by the computing system records a message. The non-transitory computer-readable storage medium also identifies an audio merge tag in the message. The non-transitory computer-readable storage medium further replaces the audio merge tag with alternative audio.

Another example embodiment includes a non-transitory computer-readable storage medium in a computing system including instructions that, when executed by the computing system provides a script to a user. The non-transitory computer-readable storage medium also receives a recorded message from the user based on the script. The non-transitory computer-readable storage medium further identifies an audio merge tag in the message. The non-transitory computer-readable storage medium additionally replaces the audio merge tag with alternative audio.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flow chart illustrating a method of creating a message using an audio merge tag;

FIG. 2 illustrates an example of a script for use with a touch tone phone or similar device;

FIG. 3 illustrates an example of a message which can be used to identify audio merge tags; and

FIG. 4 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

FIG. 1 is a flow chart illustrating a method 100 of creating a message using an audio merge tag. The method 100 can allow the message to sound natural. I.e., the method 100 can be used to create a message which sounds as if it was spoken as a complete message by a person. In particular, the method 100 can allow the message to be created without sounding synthetic, such as a computer synthesized voice, or a staccato message produced using individual words even though the message is created artificially.

FIG. 1 shows that the method 100 can include recording 102 a message. The message can be recorded 102 from a script or can be created spontaneously during recording. I.e., a user can be asked to read a script, which is then recorded and analyzed, as described below. The message can be recorded 102 using a computer, phone or any other device.

FIG. 1 also shows that the method 100 can include identifying 104 an audio merge tag within the message. The audio merge tag is any placeholder or “variable” which will be replaced with other audio. For example, the audio merge tag can include a tone, such as a tone from pressing a number key on a phone, as described below. Additionally or alternatively, the message can be analyzed based on an instruction for other data to be identified 104 as the audio merge tag. One of skill in the art will appreciate that there may be a single audio merge tag or multiple audio merge tags within the message to be identified 104.

One of skill in the art will appreciate that there may be multiple ways of identifying 104 an audio merge tag. For example, while recording 102 the message the user can press keys (e.g., phone key “1”) before saying the audio merge code (or after saying the merge tag or before and after saying the merge tag) or makes a sound such as saying (BEEEEEP at an A note frequency) before, after, or before and after saying the merge tag or saying something like STUDENT CODE STUDENT. The system (see FIG. 4) then highlights the merge tags based on the actions of the user. Additionally or alternatively, if the reader is not reading a message but only pronouncing the text (i.e., making up the message while speaking) then a menu can pop up on a screen after each signal which identifies 104 an audio merge tag. I.e., when the user presses key 1, says STUDENT, and presses key 1 again the system performs speech-to-text translation and displays a menu and asks the user to identify 104 “STUDENT” as an audio merge tag. For example it could include text which states “it appears that the word “Student” should represent an audio merge tag. Which audio merge tag should it represent: First name of Students; Last name of Students; First and Last name of Students?” The menu could also display questions to determine which groups of recipients should receive the message.

The system can use an algorithm which may find patterns in previous messages or queries a database of defined terms and performs predictive analysis on a message to identify 104 which audio merge tags are intended by the user. For example, if the user said “Dear #1 Parent #1, #2 Student #2 was absent from #3 Period #3.” the system could determine that the word “Parent” likely represented “parent names”, “Student” likely represented the name of a student of the parent, and “Period” represents the class period in which the student was absent because the user said the word “absent”. The system then provides a menu with the predicted audio merge tag and allows the user to confirm that the system's identified 104 audio merge tag is the same as the user's intended merge tag. The system also allows the user to type identify the audio merge tag by typing in the audio merge tag and selecting from a list of possible audio merge tags or selecting from a menu of possible audio merge tags other than the predicted audio merge tags.

In some embodiments, the user only has to identify an audio merge tag once, and the system will then do pattern matching and tentatively identify the other audio merge tags. For example, if a user records the following message: “Your Student code Student was absent today. Please have Student report to the attendance office tomorrow morning.”, the system can identify “Student code Student” as a merge tag because: “student” may be predefined in the system as a potential audio merge tag, the word “code” may be predefined as a signal of an audio merge tag, the A-B-A pattern of audio merge tag followed by signal word followed by audio merge tag is present, or a combination of the preceding. Once the system has identified the “Student code Student” portion as a possible audio merge tag representing “Student Name” then the system also identifies or labels the “Student” in the phrase “Student report” as a potential audio merge tag.

As used herein, “menu” may represent a visual menu, an audio menu, or a combination of both. An audio menu uses prompting such as playing a recording that states: You stated “student” please press 1 if you meant X, please press 2, if you meant X, etc.

In some embodiments, the system prompts the user with standard words which can be used to help signal audio merge tags. For example, the system could display or play a recording of the following: For the audio merge tag of “student”, please use the word “John”. For the audio merge tag of “period number” please state “first”. The user then could use the prompts to record a message such as “Your student, JOHN, was absent from FIRST period today.”, and the system would then identify 104 JOHN as a merge tag for student and FIRST as a merge tag for period number.

In some embodiments, the user selects from a menu the context of the message before recording the message and then the system uses the context of the menu to select and provide the user with appropriate prompts. For example, if the user selects the context of the message as “emergency message”, then the system may provide different menus and prompts than if the user had selected the context of the messages as “attendance message”. Additionally, the system may also use the context of the message to help identify 104 which audio merge tags are intended by the user.

FIG. 1 further shows that the method 100 can include replacing 106 the audio merge tag with alternative audio. For example, the alternative audio can include a name, date or any other desired information. A user can select the appropriate alternative audio used to replace 106 the audio merge tag. Additionally or alternatively, the alternative audio can be information which is automatically selected. For example, the date can be automatically inserted into the message without any need to input information by a user.

In some instances, names (e.g., new students, teacher, employees, volunteers, etc.), entities (such as new schools, new organizations, etc.), or other pieces of information are not associated with an audio file which was recorded by a human voice or a certain human voice which would make replacing 106 the audio merge tag with alternative audio impossible or awkward. For example, the system may have audio recordings for the names “Cindy, Geoff, and Michael”, but a user may prefer to record the names “Cindy, Geoff, and Michael” using the user's voice so that the audio files for those names will be recorded in the same voice which will be recording outgoing messages for Cindy, Geoff, and Michael (or the parents of Cindy, Geoff, and Michael).

Initially, the missing alternative audio is identified. For example, the user may be aware that the alternative audio is missing or the system can determine which piece(s) of information have not been recorded by a human voice. For example, at the beginning of a school year the system may determine that a teacher has 100 new students. The system sends a notification to the teacher and prompts the teacher to record all 100 names of the students or those names which do not have prior recordings (i.e., names of students that are the same as prior students of the teacher). The user may record directly into a microphone, may enter a phone number, call the system or otherwise communicate with the system and the user will then record the names through the phone.

One of skill in the art will appreciate that the system may determine which target words should be recorded by which individuals. For example, the system will determine whether the individuals or entities in a group are all associated with an audio file in the system. At the beginning of a school year, or when a new recipient or person associated with the message is identified or a new recipient enters the organization, such as a new student enrolling in the school, the system user would make an audio recording pronouncing the students name. This recording may be stored in a database for later access, which would then have audio files representing each student's name. When the user sends out a message with an audio merge tag for the name, the audio merge tag segment of the message is replaced with the recording of each student's name, allowing messages to all students to be personalized. This embodiment also works in a city which wants to communicate with its residents or in a large company which wants to communicate with its employees.

The alternative audio can be used to replace 106 the audio merge tag based on a predetermined preference order. One of skill in the art will appreciate that the preference order may be set for each message. For example, there are times when a synthesized voice may add emphasis to certain information such as times and dates. E.g., the preference order may be: 1) audio file of natural text such as text which was flanked by at least one other word and read by a human voice (for example, using the audio for “Peter” from the phrase “Peter is” which was generated by a human voice; 2) synthetic audio generated by a text-to-audio algorithm; and, 3) an audio file generated by prompting a user to record an audio file of a single word or a combination of words which are all used in their entirety as alternative audio. The user interface may include a menu in which the user can select which audio merge tags should be replaced with audio files which have been generated by a certain method such as text-to-voice algorithm, a recording of a human voice saying the target word within a phrase, or a recording of a human voice saying the target word.

The system may contain a library of prerecorded messages, and the system may facilitate the recording by an announcer of alternative audio which will be substituted into a prerecorded message which was previously recorded by the announcer. For example, an individual's name may be recorded by the same announcer who recorded 102 the message and associated with the individual's record. When the message is to be sent out, the name is then substituted into the original sound recording, allowing a more natural sounding message because the voice is the same between the recorded message and the inserted audio. The system may assign a unique identifier for each individual who records a message and may associate the unique identifier with each message. The system may also store the name and contact information of the announcer who recorded the message and associate that information with the unique identifier for the individual who recorded the message. In some embodiments, the contact information includes a phone number. When a user desires to add audio that replaces audio merge tags to a message, the system retrieves the unique identifier for the individual who recorded the message and sends a notification to the individual who recorded the message; the notification may be a voice message to the individual's phone number and may contain language which prompts the individual to repeat certain phrases such as “My child Peter is” or “Peter”. The system then stores the responses as alternative audio files, associates the alternative audio file with the text version of the alternative audio, and inserts the audio file into the original sound recording in the place of an appropriate merge tag.

In some embodiments, if an appropriate audio file has not been saved to the database of the system, a text-to-voice translation may be generated and substituted for the audio merge tag. In some embodiments, the system plays synthetic audio for the user and requests that the user provide feedback on whether the synthetic audio is acceptable. If no text-to-voice translation is available, or if the user does not desire that alternative audio be generated from a text-to-voice translation, then the system can send a reader a message, via email, SMS, MMS, audio message or through some other mechanism and prompt the reader, which may also be the user, to record an audio file.

One of skill in the art will also appreciate that the pronunciation of the word “Peter” is different than the word “Peter” in the phrase “your child Peter” or the phrase “your child Peter is.” Consequently, where a system user reads aloud the names of new message recipients, the system can present a script or the system user types a script, and then the system reader reads aloud the names of the message recipients as part of a phrase such as “your child Peter is”, “Peter is”, or “give Peter” where the alternative audio, that is “Peter”, is flanked by at least one other word. The system then extracts the audio recording of the name and inserts the name into the corresponding audio tag for a message.

One skilled in the art will further appreciate that the method 100 can be used to produce a message for any organization. For example, the organization could include a school, a business, a governmental entity or any other group of individuals. By way of example, a school could use the method 100 in telephone messages used to communicate with recipients, such as parents. E.g., at the beginning of a school year, or when a new student or other message recipient enters the school, such as a new student enrolling in the school, the system user would make an audio recording pronouncing the student's name. This recording would be stored in a database for later access, which would then have audio files representing each student's name. When the user sends out a message with an audio merge tag for the name, the audio merge tag segment of the message is replaced with the recording of each student's name, allowing messages to all students to be personalized. For example, electronic attendance records can be checked and a message can be created for each student which is absent. At a predetermined time, messages can be sent out to each household with an absent student to alert the student's parents or guardians that the student is marked as absent. Thus, human error, which may prevent a desired message from being sent, can be eliminated.

Additionally or alternatively, a user can determine which recipients should receive a message. For example, a menu may be displayed after the user has recorded the entire message. E.g., a user can select whether the message should be sent to parents of students, the students, or both the parents of the students or some other grouping of individuals. Additionally or alternatively, in an organization with hierarchy levels such as a school district, the user can be assigned permissions to send messages to different levels of the organization. For example, a superintendent who has logged into the system and recorded a message with audio merge tags will have the option of sending the message to the entire district, a school in the district, or by selecting a geographical area on a map and sending to all known home phone numbers and devices within that geographical area.

One skilled in the art will additionally appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 2 illustrates an example of a script 200 for use with a touch tone phone or similar device. I.e., the user can use a touch tone phone to record a message based on the script 200 which will then be used to create personalized messages based on the script 200. In particular, the touch tone phone can be used to both create the message and to identify the portions which should be individualized.

FIG. 2 shows that the script 200 can include common text 202. The common text 202 includes information that is to be included in every message. I.e., the common text 202 is audio that remains the same, regardless of other information in the message, which can be personalized. In most instances, the common text 202 will be the most common text within the message. Thus, using the common text 202 can be recorded a single time, while allowing hundreds or thousands of messages to be created automatically.

FIG. 2 also shows that the script 200 can include an audio merge tag 204. The audio merge tag 204 can include an instruction to press a particular phone key. For example, the audio merge tag 204 can be any recognizable touch tone (i.e., the user can press any phone key) or can include a particular key that the user is instructed to push. For example, the user can push “1” whenever an audio merge tag 204 needs to be inserted rather than reading text or pausing. Additionally or alternatively, the user can be instructed to push a number corresponding to individual audio merge tags 204 (i.e., “1” for the first audio merge tag 204, “2” for the second audio merge tag 204, etc.)

FIG. 3 illustrates an example of a message 300 which can be used to identify audio merge tags. For example, the user creates a script that says “Your child, John, was late to fourth period.” The user can then identify information within the script which will include an audio merge tag. For example, the user can highlight the words “John” and “fourth” to indicate to the system that the identified words or phrases should be considered an audio merge tag.

FIG. 3 shows that a synthetic message 302 or “computer version” of the script can be created. I.e., the script can be converted into a synthetic message 302 using a computer, a phone or any other electronic device. For example, the synthetic message 302 can be created using a process which identifies each word of the script and inserts a standard audio signal for the word, regardless of the place of the word within the message (i.e., ignoring the proper emphasis or inflection which should be given to the word based on its place within the sentence).

FIG. 3 also shows that an audio merge tag 304 can be identified within the synthetic message 302. In particular, the audio merge tag 304 can be flagged based on the identification made within the script. I.e., the synthetic message 304 is created the same regardless of the presence or absence of audio merge tag 304. However, the audio merge tag 304 is identified to assist in later analysis, as described below.

FIG. 3 further shows that a spoken message 306 based on the script can be created. The spoken message 306 can be created using any desired method. For example, the script can be presented to a user who then reads the script in order to create the spoken message 306. The user can record the spoken message 306 using a phone, a microphone, a computer or using any other desired message.

FIG. 3 additionally that the synthetic message 302 and the spoken message 306 are similar to each other although not necessarily the exact same. For example, the spoken message 306 will have significantly more noise. In addition, the spacing and/or tempo of the spoken message 306 will vary from the synthetic message 302. Nevertheless, the synthetic message 302 and the spoken message 306 share many characteristics.

FIG. 3 moreover shows that the portion 308 of the spoken message 306 which corresponds to the audio merge tag 304 can be identified. I.e., because the synthetic message 302 and the spoken message 306 are similar, the portion 308 of the spoken message which corresponds to the audio merge tag 304 can be identified automatically. Therefore, the portion 308 can be replaced to produce custom messages with the desired information.

In at least one implementation, the system can also provide feedback to the user. I.e., the system can add language at the end of each message (for example, if selected by the sender) which informs the sender if an audio tag is identified as incorrect by the system or by other users. For example, if a city street is called Rennault Street and the voice message uses an incorrect pronunciation for Rennault Street, then the user can respond to the message including, potentially, recording a different pronunciation. A message will then be sent to an administrator listing the original message, the recording of feedback, and an option for the administrator to approve the recording as the new audio file for the target word or call the individual administrator with a prompting for the administrator to pronounce the word which triggered the incorrect pronunciation. In some embodiments, the system sends user recordings for student's names that occur less frequently than some names such as Konichisapa and thus are more likely to be mispronounced by a text to speech algorithm or generator or by a human so that the user can confirm that the system's audio file for that name is correct. Additionally or alternatively, the system can prompt the user to record an audio file for those names or pieces of information which it has identified using statistical analysis or through user feedback as unusual or difficult to pronounce.

FIG. 4, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an example system for implementing the invention includes a general purpose computing device in the form of a conventional computer 420, including a processing unit 421, a system memory 422, and a system bus 423 that couples various system components including the system memory 422 to the processing unit 421. It should be noted however, that as mobile phones become more sophisticated, mobile phones are beginning to incorporate many of the components illustrated for conventional 420. Accordingly, with relatively minor adjustments, mostly with respect to input/output devices, the description of conventional computer 420 applies equally to mobile phones. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 20 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, motion detectors or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 can be connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In an alternative embodiment the system searches the database for a specific sender's voice files and uses those files in first priority. Thus, if one student has six different teachers, each teacher can send messages that are in the natural voice of that teacher.

In an alternative embodiment, when the system does not contain files of the specific sender's voice dictating the message material, the system searches the database for the appropriate alternative audio recorded by someone other than the sender. Many different embodiments of this method include, but are not limited to: searching for any voice from the same gender as the sender; using voice tone, pitch, frequency, etc. to find the most similar recording; using recorded voice material provided by the intended recipient or someone with a guardian relationship with the recipient; using an independent database with samples of similar voices; etc.

An embodiment includes allowing each sender to customize the priority the system uses to searches the database for similar voice material to be used in lieu of their own. A message sender may elect to have the system request that the message sender record additional alternative audio when the system determines that the database does not contain alternative audio which was recorded by the message sender but is supposed to be used in the message. Another embodiment is to allow a message sender to configure a list of priorities for which the system will search for alternative audio. Various methods in which the system obtains alternative audio include but are not limited to: prompting the sender to record any alternative audio if some of the alternative audio files for the message were not recorded in the sender's voice, using text-to-speech generated audio files, using alternative audio files which were recorded by an individual associated with the message recipient (e.g., another teacher of the message recipient), or using alternative audio which was recorded by someone of the same gender as the message sender. In other embodiments, an administrator may set the priority.

In some embodiments, the system allows message recipients to provide a voice recording of their own name and provide it for uploading to the database. Various methods of collecting voice recordings of new message recipients (e.g. new employees, students, etc.) include sending a message to the message recipient or a guardian of the message recipient, sending a message with a link to the message recipient or a guardian of the message recipient, sending a notification to a message recipient's mobile device, using a phone line to record the voice, capturing audio in person, capturing audio through online video conferencing services, and any other form of audio capture and transfer.

What is claimed is:

1. A method of creating a message, the method comprising:
recording a message;
identifying an audio merge tag in the message; and
replacing the audio merge tag with alternative audio.

2. The method of claim 1, wherein recording a message includes prompting a user to record a message.

3. The method of claim 2, wherein prompting a user to record a message includes providing a script to the user.

4. The method of claim 3, wherein the script includes identification of the audio merge tag text.

5. The method of claim 2, wherein prompting a user to record a message includes the user creating a script.

6. The method of claim 3, wherein the user identifies the audio merge tag during creation of the script.

7. The method of claim 1, wherein recording the message includes a user recording the message on a touch tone phone.

8. The method of claim 7, wherein the user identifies the audio merge tag by pressing a key on the touch tone phone.

9. The method of claim 8, wherein the key includes the “1” key.

10. The method of claim 9 further comprising:
the user identifying a second audio merge tag in the message by pressing the “1” key on the touch tone phone a second time.

11. The method of claim 9 further comprising:
the user identifying a second audio merge tag in the message by pressing the “2” key on the touch tone phone.

12. The method of claim 1 further comprising:
prompting a user to record the alternative audio if the alternative audio does not exist.

13. The method of claim 1 further comprising:
prompting a user to record the alternative audio if the alternative audio does not exist in the user's voice.

14. In a computing system, a non-transitory computer-readable storage medium including instructions that, when executed by the computing system, performs the steps:
recording a message;
identifying an audio merge tag in the message; and
replacing the audio merge tag with alternative audio.

15. The system of claim 14 further comprising:
recording a second message, wherein the second message includes the alternative audio.

16. The system of claim 15, wherein the second message includes audio before and after the alternative audio.

17. The system of claim 14 further comprising:
creating a synthetic message; and
comparing the synthetic message and the message to identify the audio merge tag.

18. In a computing system, a non-transitory computer-readable storage medium including instructions that, when executed by the computing system, performs the steps:
providing a script to a user;
receiving a recorded message from the user based on the script;
identifying an audio merge tag in the message; and
replacing the audio merge tag with alternative audio.

19. The system of claim 18, wherein the script includes identification of the audio merge tag text.

20. The system of claim 18, wherein the user identifies the audio merge tag during creation of the script.

21. The system of claim 18 further comprising:
creating a synthetic message; and
comparing the synthetic message and the recorded message to identify the audio merge tag.

22. The system of claim 18 further comprising:
recording a second message, wherein the second message includes the alternative audio.

23. The system of claim 18 further comprising:
providing feedback to the user if either:
the audio merge tag is incorrect; or
the alternative audio is incorrect.

24. The system of claim 23, wherein the feedback includes prompting the user to make a corrected recording.

25. The system of claim 23, wherein the feedback includes allowing the user to accept a corrected recording.

26. The system of claim 18 further comprising:
using predictive analysis to identify at least one of:
the audio merge tag; or
the alternative audio.

27. The system of claim 18 further comprising:
presenting a menu to the user, wherein the menu:
identifies an audio merge tag for the user;
allows the user to select an identifier which indicates the alternative audio which should be used, such as the recipient's name;
presents a list of intended recipients; or
presents one or more questions to the user.

28. The system of claim 27 wherein the menu includes an audio menu.

29. The system of claim 27 wherein the menu includes a visual menu.
